(19) United States
(12) Patent Application Publication
(10) Pub. No.: US 2012/0210536 A1
(43) Pub. Date: Aug. 23, 2012

(54) VEHICULAR VACUUM CLEANING SYSTEM

(76) Inventors: Shay Jan, Yahud (IL); Avihay Jian, Yahud (IL)

(21) Appl. No.: 13/384,242

(22) PCT Filed: Nov. 2, 2011
(86) PCT No.: PCT/IL11/00850

§ 371 Date: Jan. 16, 2012

(30) Foreign Application Priority Data
Nov. 2, 2010 (IL) 209071

(51) Int. Cl. B60S 1/64; A47L 9/24; A47L 9/28

(52) U.S. Cl. 15/313

(57) ABSTRACT

A vehicular vacuum cleaning system, comprising: a vacuum pump; a control unit; an ashtray cleaning subsystem, and a cabin vacuum cleaning subsystem; wherein said ashtray cleaning subsystem comprises for each of at least one ashtray of said vehicle: a conduit connecting the ashtray to said vacuum pump through said control unit; for each of the ashtrays connected to said vacuum pump: a sensor for sensing when said ashtray is open/closed, thereby providing indication to said control unit to activate/deactivate said vacuum pump to draw air through said conduit; and wherein said cabin vacuum cleaning subsystem comprises: an extendable conduit; a lid, for covering the intake of said extendable conduit when not in use; a sensor for sensing when said lid is open/closed, thereby providing indication to said control unit to activate/deactivate said vacuum pump to draw air through said extendable conduit.

### FIELD OF THE INVENTION

The present invention relates to the field of vacuum cleaners. More particularly, the invention relates to a vehicular vacuum cleaning system.

### BACKGROUND OF THE INVENTION

These days, vehicles do not include integral cleaning devices. As a result, cleaning a vehicle is carried out mostly in car wash facilities, and therefore usually is not undertaken as often as necessary. The problem is acute especially for ashtrays, which in a smoker's vehicle should be emptied much more often than the car is washed. As such, when an ashtray fills up, the vehicle owner may throw the ash and waste accumulated in the ashtray outside the vehicle, and not necessarily in a garbage tray.

It is an object of the present invention to provide a solution to the above-mentioned and other problems of the prior art.

Other objects and advantages of the invention will become apparent as the description proceeds.

### SUMMARY OF THE INVENTION

A vacuum cleaning system for a vehicle, the system comprising:

a vacuum pump (12);

a control unit (26);

an ashtray cleaning subsystem, comprising:
for each of at least one ashtray (16) of said vehicle (10), a conduit (28) connecting the ashtray (16) to said vacuum pump (12) through said control unit (12);
for each of the ashtrays (16) connected to said vacuum pump (12), a sensor (34) for sensing when said ashtray (16) is open/closed, thereby providing indication to said control unit (26) to activate/deactivate said vacuum pump (12) to draw air through said conduit (28);

a cabin vacuum cleaning subsystem, comprising:
an extendable conduit (22);
a lid (14), for covering the intake of said extendable conduit when not in use;
a sensor (40) for sensing when said lid (14) is open/closed, thereby providing indication to said control unit (26) to activate/deactivate said vacuum pump (12) to draw air through said extendable conduit (22);
   thereby facilitating cleaning the cabin (10) of said vehicle, and keeping said cabin clean.

According to one embodiment of the invention, the operation of said control unit is based on one or more valves.

According to one embodiment of the invention, the operation of said sensor is based on a switch that opens/closes an electric circuit.

According to one embodiment of the invention, the communication channel is wired.

According to another embodiment of the invention, said communication channel is wireless.

According to one embodiment of the invention, the extendibility of said conduit is obtained by a cylinder around which said conduit is rolled, and a spiral spring used as auto return mechanism.

According to another embodiment of the invention, the extendibility of said conduit is obtained by a springy-spiral form of the conduit, as illustrated in FIG. 6.

According to one embodiment of the invention, the system is adapted to insert the waste of the vacuum cleaning into a bag. The system may further comprise a sensor for sensing whether the bag is full. The system may be further adapted to prevent the pumping thereof upon sensing that the bag is full.

According to one embodiment of the invention, the system is adapted to throw the waste of the vacuum cleaning outside the vehicle.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a cabin 10 of a vehicle, in which is installed an integral vacuum cleaner, according to one embodiment of the invention.

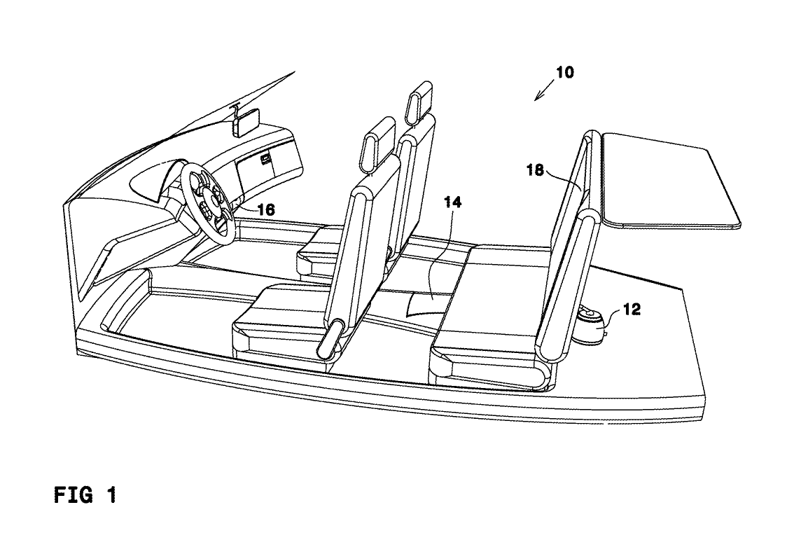

FIG. 2 focuses on the cabin cleaning subsystem of the integral vacuum cleaner.

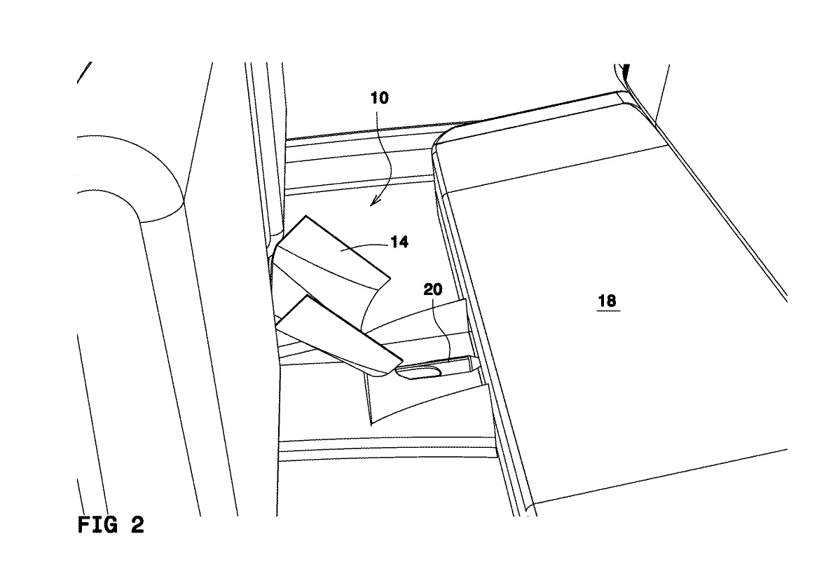

FIGS. 3 and 4 further detail the cabin cleaning subsystem of the integral vacuum cleaner.

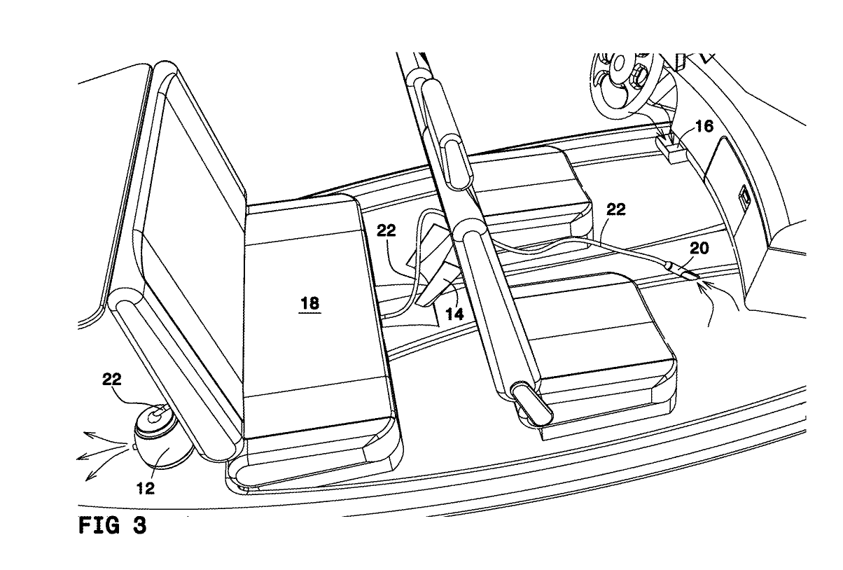

FIG. 4 schematically illustrates an extendable conduit, according to one embodiment of the invention.

FIG. 5 is a block diagram that illustrates the air passage of the integral vacuum cleaner.

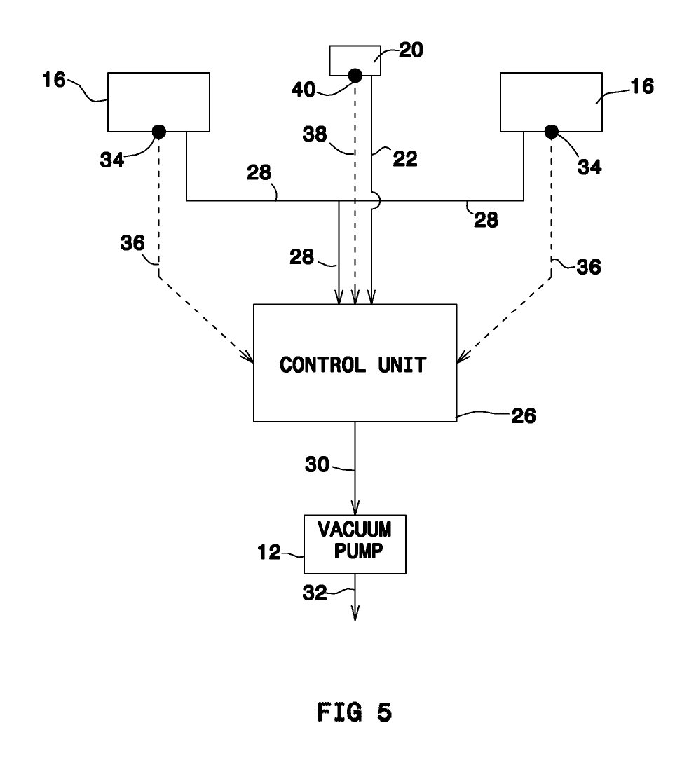

FIG. 6 schematically illustrates an extendable conduit, according to another embodiment of the invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

In the embodiment illustrated in the figures herein is presented a vacuum cleaning system, according to one embodiment of the invention.

The vacuum cleaning system comprises two subsystems, one for drawing air from the ashtrays of the vehicle, and the other for providing to a user a vacuum cleaner available for use from inside the vehicle's cabin.

Each of these subsystems is connected via a conduit to a vacuum pump 12 through a control unit 26. As a plurality of conduits are connected to the vacuum pump, the object of the control unit is to enable/disable air passageway via each conduit, which can be carried out, for example, by valves, and so on.

As per the ashtrays cleaning subsystem, each of the ashtrays 16 of the vehicle is connected via a conduit 28 to the vacuum pump 12, through control unit 26.

The control unit may be embodied as a sealed container to which the conduits 28 and 22 are connected. The valves (not shown) that enable/disable the air passage from a conduit by valves are controlled by a circuitry that changes the state of the valves. The sensors are connected to the circuitry by communication channel 36, such as wired communication, wireless communication, and so on. Although the use of wireless communication is more complicated, it facilitates the installation of the system, since it does not require wires.

To each of the ashtrays there is connected a sensor 34, such as a switch, which indicates, through a communication channel 36 (such as a cable), to control unit 26, if the ashtray is open/closed. The control unit activates/deactivates pumping of vacuum pump 12 through an ashtray responsively to changing the state of an ashtray from closed to open and from open to closed, respectively.

For example, assuming all the ashtrays are closed, upon indicating opening an ashtray 16, control unit 26 activates pumping from conduit 28, the end thereof is used as the intake of the conduit, and conveys the content of the ashtray out of the vacuum pump. Upon indicating closing all ashtrays 16, the control unit deactivates the pumping from this conduit.

In addition to the ashtray cleaning subsystem, there is installed in the vehicle a cabin cleaning subsystem. The cabin cleaning subsystem may comprise: an extendable conduit 22; a lid 14, for covering intake 20 of extendable conduit 22 when not in use; and a sensor 40, for sensing when lid 14 is open/closed, thereby providing indication to control unit 26 to activate/deactivate vacuum pump 12 to draw air from intake 20, through extendable conduit 22.

According to one embodiment of the invention, exit 32 from the vacuum pump is directed to a bag (not illustrated). Thus, the user thereof has to dispose of the accumulated content.

According to another embodiment of the invention, exit 32 from the vacuum pump is directed outside the vehicle, thereby rendering unnecessary the use of a bag. Since the emitted ash and waste is not accumulated in the ashtrays, even if the content is dispersed outside the vehicle, the polluting effect thereof is minor.

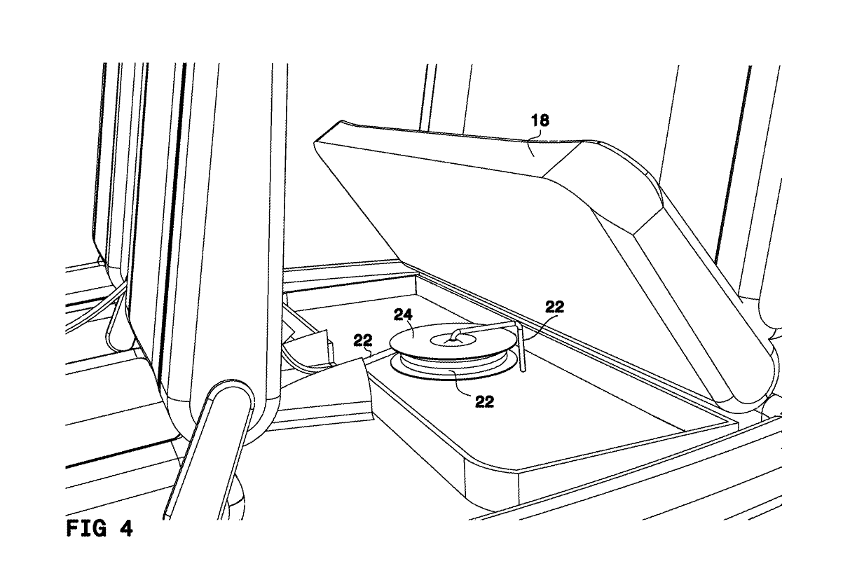

Referring to FIG. 4, an extendable conduit mechanism is illustrated, which employs a cylinder 24, along which conduit 22 is rolled, and a spiral spring (not shown), which is used as an auto return mechanism.

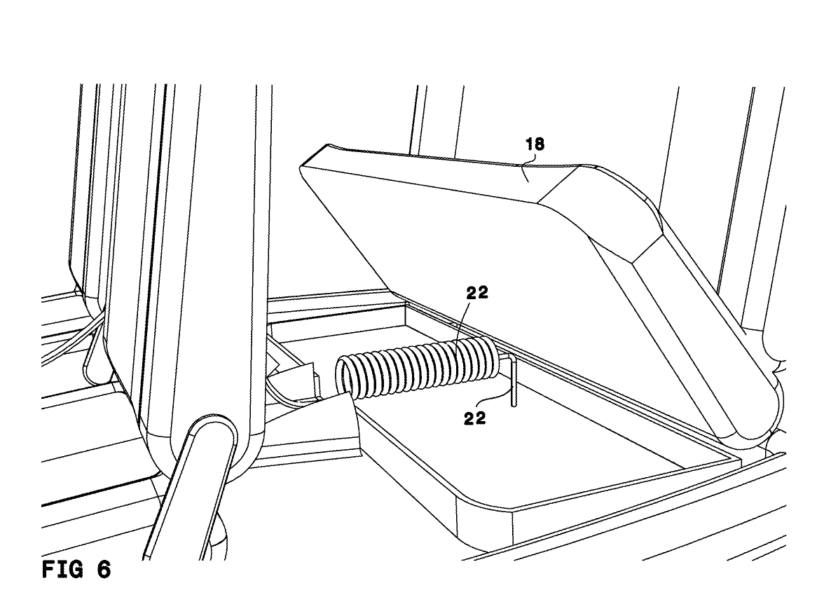

FIG. 6 schematically illustrates an extendable conduit, according to another embodiment of the invention.

According to this embodiment of the invention, conduit 22 has a springy-spiral form, thereby achieving the extending characteristics.

In the figures and/or description herein, the following reference numerals have been mentioned:
numeral 10 denotes a cabin of a vehicle;
numeral 12 denotes a vacuum pump;
numeral 14 denotes a lid that covers the intake of conduit 22;
numeral 16 denotes an ashtray;
numeral 18 denotes the backseat of cabin 10;
numeral 20 denotes the intake of conduit 22;
numeral 22 denotes an extendable conduit from control unit 26 to cabin 10;
numeral 24 denotes a cylinder around which conduit 22 is rolled, in order to be extended;
numeral 26 denotes a control unit;
numeral 28 denotes a conduit that connects control unit 26 with ashtrays 16;
numeral 30 denotes a conduit that connects vacuum pump 12 with control unit 26;
numeral 32 denotes an exit from vacuum pump 12;
numeral 34 denotes a sensor, such as a switch, for detecting whether an ashtray 16 is open/closed;
numeral 36 denotes a communication channel (such as a cable ore wireless communication means), for passing the indication of sensor 34 to control unit 26;
numeral 38 denotes a communication channel (such as a cable), for passing information from sensor 40 to control unit 26; and
numeral 40 denotes a sensor (such as a switch), for sensing whether lid 14 is open/closed.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A vacuum cleaning system for a vehicle, the system comprising:
a vacuum pump;
a control unit;
an ashtray cleaning subsystem, comprising:
for each of at least one ashtray of said vehicle: a conduit connecting the ashtray to said vacuum pump through said control unit;
for each of the ashtrays connected to said vacuum pump: a sensor for sensing when said ashtray is open/closed, thereby providing indication to said control unit to activate/deactivate said vacuum pump to draw air through said conduit;
a cabin vacuum cleaning subsystem, comprising:
an extendable conduit;
a lid, for covering the intake of said extendable conduit when not in use;
a sensor at said lid, for sensing when said lid is open/close, thereby providing indication to said control unit to activate/deactivate said vacuum pump to draw air through said extendable conduit;
thereby facilitating cleaning the cabin of said vehicle, and keeping said cabin clean.

2. A vacuum cleaning system according to claim 1, wherein the operation of said control unit is based on one or more valves.

3. A vacuum cleaning system according to claim 1, wherein said sensor is based on a switch that opens/closes an electric circuit.

4. A vacuum cleaning system according to claim 1, wherein said communication channel is wired.

5. A vacuum cleaning system according to claim 1, wherein said communication channel is wireless.

6. A vacuum cleaning system according to claim 1, wherein the extendibility of said conduit is obtained by a cylinder around which said conduit is rolled, and a spiral spring used as auto return mechanism.

7. A vacuum cleaning system according to claim 1, wherein the extendibility of said conduit is obtained by a springy-spiral form.

8. A vacuum cleaning system according to claim 1, wherein the exit from said vacuum pump is directed to a bag, for storing the waste thereof.

9. A vacuum cleaning system according to claim 8, further comprising a sensor for sensing whether said bag is full.

10. A vacuum cleaning device according to claim 9, further adapted to prevent a pumping thereof upon sensing that said bag is full.

11. A vacuum cleaning system according to claim 1, wherein the exit from said vacuum pump is directed to the outside of said vehicle.
